(19) United States
(12) Patent Application Publication
(10) Pub. No.: US 2015/0346329 A1
(43) Pub. Date: Dec. 3, 2015

(54) ULTRALIGHT LASER INFRARED COUNTERMEASURE (IRCM) SYSTEM

(71) Applicant: BAE SYSTEMS INFORMATION AND ELECTRONIC SYSTEMS INTEGRATION INC., Nashua, NH (US)

(72) Inventors: PAUL I. EGBERT, Merrimack, NH (US); MICHAEL J. POWERS, Amherst, NH (US); ANDREW J. RADL, Dunbarton, NH (US); ALDRIDGE G. SOWER, Boston, MA (US); EDWARD G. ZABLOCKI, North Andover, MA (US)

(21) Appl. No.: 14/308,740

(22) Filed: Jun. 19, 2014

Related U.S. Application Data
(60) Provisional application No. 61/842,725, filed on Jul. 3, 2013.

(51) Int. Cl. G01S 7/495

(52) U.S. Cl. CPC G01S 7/495

(57) ABSTRACT

An ultralight laser infrared countermeasure (IRCM) system is disclosed. In One embodiment, the system includes an ultra light housing. The system further includes a laser or an infrared missile warning sensor to provide imagery data upon detecting a threat infrared surface to air missile (IRSAM). The ultralight housing is further configured to include at ultralight laser infrared assembly, which includes a laser, and laser pointer assembly. The ultralight housing is furthermore configured to include a missile warning processing module to produce a track point for the laser and to produce a modulation signal based on the imagery data, wherein the ultralight laser infrared assembly to modulate the laser pointer assembly based on modulation signal for a predetermined length of time to provide multiple simultaneous IRSAM engagement protection.

### CROSS-REFERENCE TO RELATED APPLICATIONS

This Application claims rights under 35 USC §119(e) from U.S. Application 61/842,725 filed Jul. 3, 2013, the contents of which are incorporated herein by reference.

### BACKGROUND OF THE INVENTION

1. Field of the Invention

The present invention relates to missile countermeasures and more particularly to countermeasures to infrared guided missiles.

2. Brief Description of Related Art

Conventional laser countermeasure systems are suitable for large rotary and fixed ins aircraft, but n some scenario they may be too heavy, for example, smaller rotary wing platforms or unmanned airborne vehicles (UAVs). Distributed countermeasure systems integrate missile warning and laser jamming devices into one Line Replaceable Unit (LRU). However, the laser jamming device remains a separate centralized LRU connected via a fiber distribution network to the pointer(s). The fiber distribution network may be logistically problematic and may incur laser signal loss in the fiber, which may prevent deployment of such systems. Further, distributed countermeasure systems may not meet the size, weight, and cost requirements for smaller aircraft.

### SUMMARY OF THE INVENTION

An ultralight laser infrared countermeasure (IRCM) system is disclosed. According to one aspect of the present subject matter, the system includes an ultralight housing, a laser or an infrared missile warning sensor configured to provide imagery data upon detecting a threat infrared surface to air missile (IRSAM), an ultralight laser infrared assembly, wherein the laser or an infrared missile warning sensor and the ultralight laser infrared assembly are disposed to provide the needed alignment and orientation in the ultralight housing. The ultralight laser infrared assembly includes a laser, a laser pointer assembly, and a missile warning processing module disposed in the housing to produce a track point for the laser and to produce a modulation signal based on the imagery data. The ultralight laser infrared assembly is configured to modulate the laser pointer assembly based on modulation signal for a predetermined length of time to provide multiple simultaneous IRSAM engagement protection.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a schematic diagram of a front perspective view of an ultralight laser infrared countermeasure (IRCM) system, according to an example embodiment of the present subject matter.

FIG. 2 is a schematic diagram of a rear perspective view of the IRCM system, such as those shown in FIG. 1, according to an example embodiment of the present subject matter.

FIG. 3 is a schematic diagram of a rear perspective view, without the rear cover, showing major components of the IRCM system, such as those shown in FIGS. 1 and 2, according to an example embodiment of the present subject matter.

FIG. 4 is a schematic drawing illustrating how the IRCM system, such as those shown in FIGS. 1-3, is designed to use existing aircraft installations to facilitate installation of the IRCM system without needing any major modifications, according to an example embodiment of the present subject matter.

FIG. 5 is a schematic drawing illustrating functional resources that are available to provide any additional functionality needed for the IRCM system, such as those shown in FIGS. 1-3, according to an example embodiment of the present subject matter.

### DETAILED DESCRIPTION OF THE INVENTION

The exemplary embodiments described herein in detail for illustrative purposes are subject to many variations in structure and design. The present technique provides an ultralight laser infrared countermeasure (IRCM) system that is small, light and cheaper and suitable for smaller aircrafts and/or unmanned airborne vehicles (UAVs). The ultralight IRCM includes all the resources necessary to perform the missing warning functions within in the system/device locally. The ultralight IRCM has the processing capacity to perform Uniformly Most Probable (UMP) detections. Further the ultralight IRCM has the ability to accept cues from the missile warning system it is attached to improve declaration confidence and track accuracy. Moreover each ultralight IRCM system can be configured to function independently; a configuration with an ultralight laser IRCM system on each sensor provides the platform with multiple simultaneous infrared surface to air missile (IRSAM) engagement protection. Each sensor performs both the missile warning function and the angular tracking vecrot for the laser pointing function.

The terms “ultralight Line Replaceable Unit” and “ultralight laser infrared countermeasure system” are being used interchangeably throughout the document.

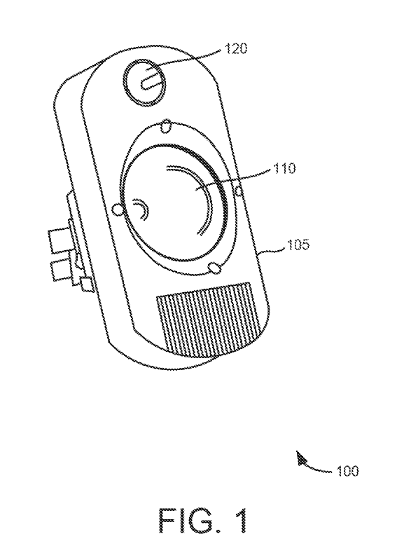

FIG. 1 is a schematic diagram of a front perspective view of an ultralight laser infrared countermeasure (IRCM) system 100, according to an example embodiment of the present subject matter. As shown in FIG. 1, the IRCM system 100 includes an ultralight housing 105 that is configured to house a laser or an infrared missile warning sensor 110. Exemplary laser or infrared missile warning sensor 110 are an imaging ultraviolet (UV) or infrared (IR) local place array (FPA) based missing warning sensor. Also as shown in FIG. 1, the ultralight housing includes a laser output aperture 120.

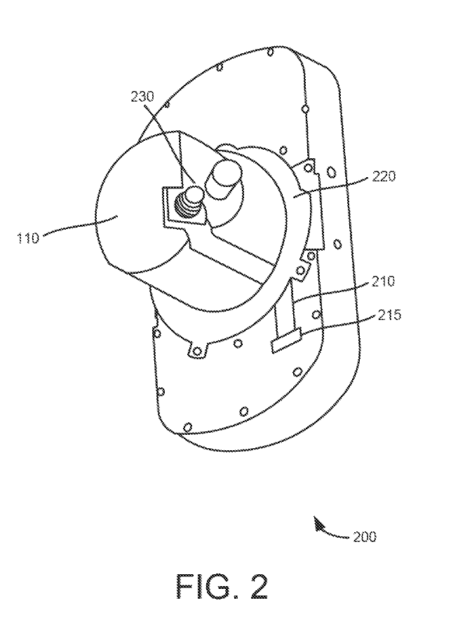

FIG. 2 is a schematic diagram of a rear perspective e of the IRCM system 200, such as those shown in FIG. 1, according to an example embodiment of the present subject matter. Further, FIG. 2 shows a recessed channel 210 for a flat cable, a recessed cavity 215 for a micro-D connector (up to 24 American Wire Gage (AWG) pins), a conductive ring 220 to protect flat cable 210 from being crushed and to maintain needed interface flatness and to further provide bonding path from electro-optics missile sensor (EOMS) to A-Kit. Furthermore, FIG. 2 shows a connector bracket that is configured to fasten to existing ground stud hole. It can be seen in FIG. 2, the IRCM system 200 is designed to use mechanical and electrical connections of existing aircraft installation (A-Kit) to significantly reduce any modifications needed to be used in existing aircraft configurations.

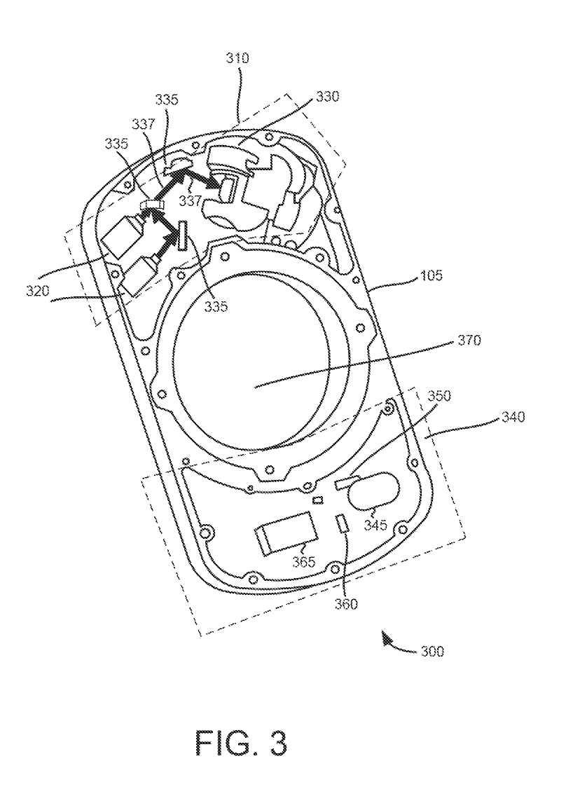

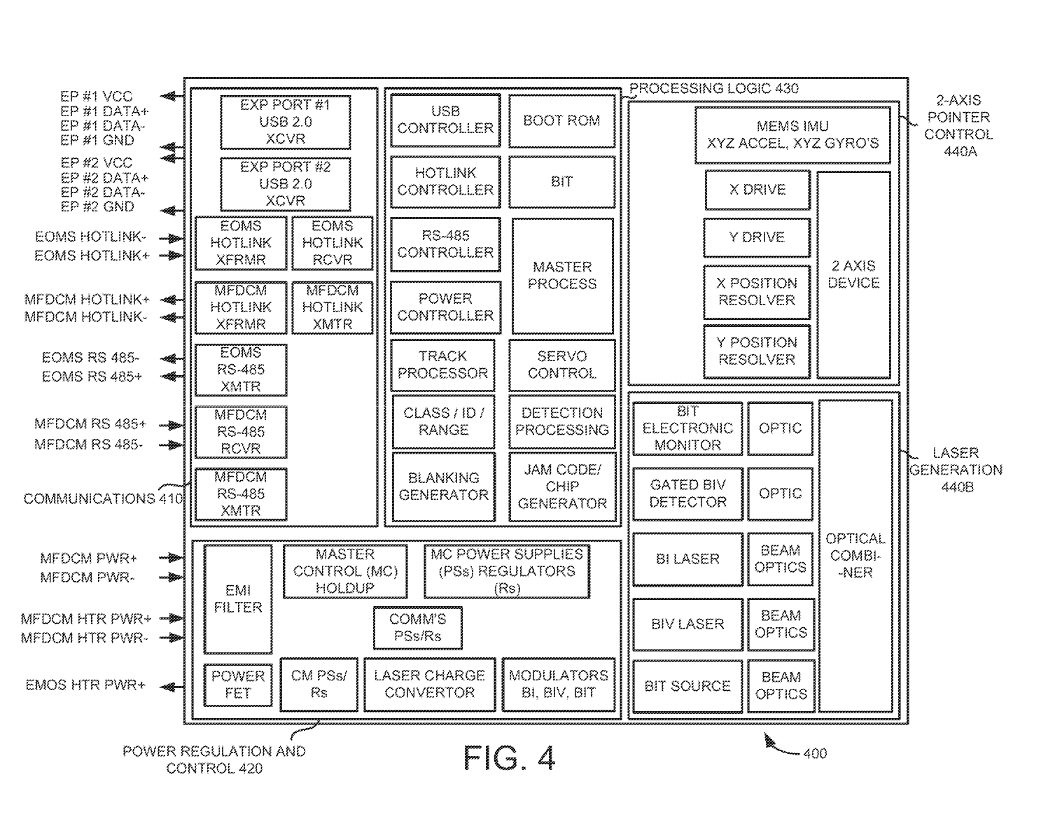

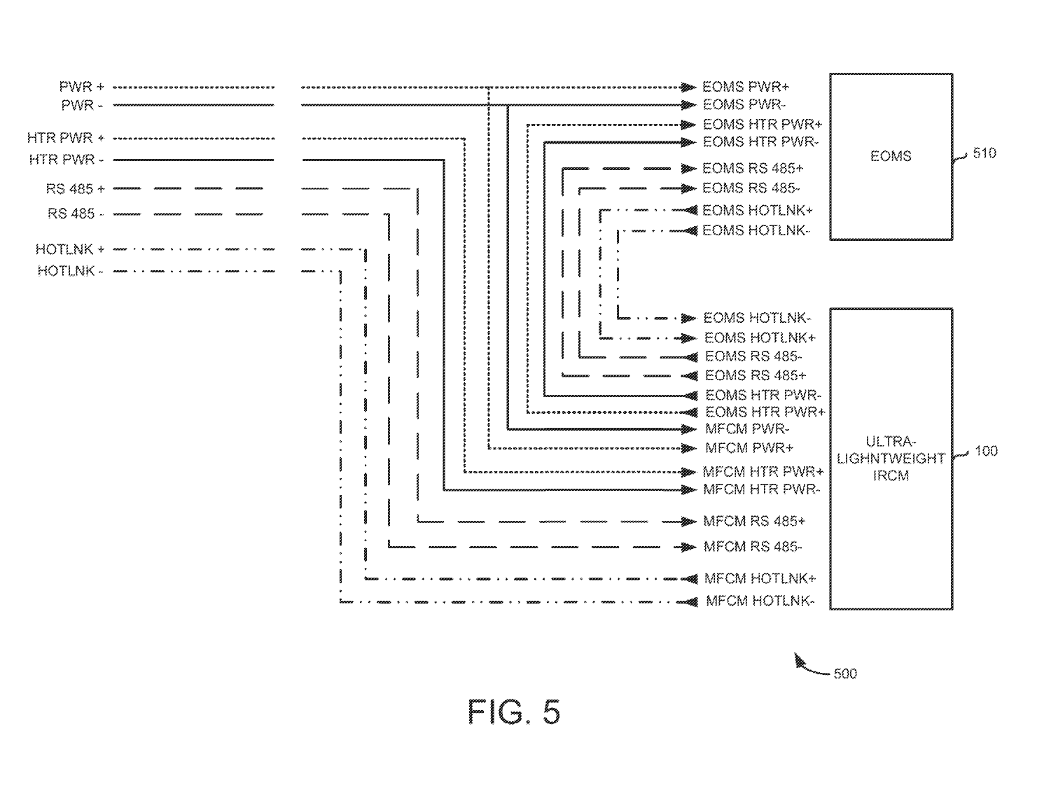

FIG. 3 is a schematic diagram of a rear perspective view, without the rear cover and without the sensor, showing major components of the IRCM system 300, such as those shown in FIGS. 1 and 2, according to an example embodiment of the present subject matter. As shown in FIG. 3, the IRCM system includes an ultralight laser infrared assembly 310 and an electronic cavity 340. Further as shown in FIG. 3, the ultralight laser infrared module 310 includes a laser(s) 320 and a laser pointer assembly 330. Furthermore as shown in FIG. 3, the electronic cavity 340 includes a missile warning processing module, which in turn includes a missile warning processor 345, such as a field program cable gate array (FPGA) processor, an inertial measurement unit (IMU) 350, a local energy storage capacitance 355 for power hold-up and laser modulation, laser driver electronics 360, and a pointer servo control driver electronics 365. It can be seen in FIG. 3 that the ultralight laser infrared assembly 310 and the electronic cavity 340 surrounds the laser or the infrared missile warning sensor 110 and the laser or the infrared missile warning sensor aperture opening 370 shown in FIG. 1 and FIG. 3, respectively. Further it can be seen in FIG. 3, that the ultralight laser infrared assembly 310 and the laser or the infrared missile warning sensor are configured to dispose in the ultralight housing to provide needed alignment between the laser or the infrared missile warning sensor 110 to the laser pointer assembly 330 for pointing and to further provide needed orientation bet peen a tracker image and the laser or the infrared missile warning sensor 100. Furthermore, the laser or the infrared missile waning sensor 110, the missile warning processing module 340 and the ultralight laser infrared assembly 310 are inserted and coupled electrically in series so as to have access to all imagery data received from the laser or the infrared missile warning sensor 110 and system status data from the missile warning processor 345. The ultralight IRCM system 100 shown in FIGS. 1-3 also has the ability to store energy locally in local energy storage 355 so as to not to increase power load or exceed electrical load requirements for safety. Locally stored energy is used to drive Jam codes optimized for the low IR platform signatures and low Jam to Signal (J/S) ratios in order to create optical break lock (OBL) with the threat from an IRSAM. A local IMU is used to cancel platform motion as shown in the example block diagram shown in FIG. 4. Further it can be seen in FIGS. 4 and 5 the proposed technique provides resources (external ports J2 and J3 and mounting hardware with datums) to accommodate additional functionality as needed. Exemplary shown functionalities are Acoustic Fire Indication (AHFI) and High Angular Resolution Laser Irradiance Detector (HARLID) for laser warning functions. Moreover the ultralight IRCM system 100 has all the resources needed to perform the missing warning function locally. Also the ultralight IRCM system 100 has the processing capacity to perform Uniformly Most Probable (UMP) detections via signal processing techniques. In addition, the ultralight IRCM system 100 has the ability to accept cues from the missile warning system it is attached to improve declaration confidence and track accuracy.

Example ultralight laser infrared assembly 310 shown in FIG. 3 includes the laser 320, such as solid state semiconductor laser emitters based on InP direct emitter and Quantum Cascade (QCL) emitter for multiband coverage. Exemplary laser 320 is Band 1 and Band 4 lasers. In these embodiments, the infrared missile warning sensor 110 is configured to detect photons from a threat infrared surface to air missile (IRSAM) and provide imagery data on a frame-by-frame basis. Exemplary ultralight laser infrared assembly 310, such as those shown in FIG. 3, is a 2 axis micro-gimbal steerable mirror assembly that is capable of pointing laser. It can be seen in FIG. 3 that the laser 320 along with the laser pointer assembly (i.e., the two lasers 320 along with the folding mirror and beam combining optics 335) direct combined laser beams 337 to laser pointer assembly 330. In these embodiments, the missile warning processor, such as the FPGA processor 345 shown in FIG. 3, provides the infrared missile warning sensor image processing for missile detection and tracking. Further the FPGA processor 345 is configured to generate laser jam code. Furthermore the FPGA processor 345 is configured to point servo control loop and have built-in-test (BIT) function capabilities. Also, in these embodiments, IMU provides control loop with pointing compensation for angular movement of LRU.

In operation, the laser or the infrared missile warning sensor 110 provides imagery data upon detecting a threat from IRSAM. In some embodiments, once given a cue, the missile warning processing module 340 has the ability to use the imagery data received from the laser or the infrared missile warning sensor 110 and develop a track point for the ultralight laser infrared assembly 310. In these embodiments, photons irradiated from a threat IRSAM are detected by the infrared missile warning sensor 110, either in the UV or IR bands, and are converted into electrons and are read out as a frame of imagery data. Further in these embodiments, each frame of imagery data is transmitted via A-Kit cabling 210 located back of the laser or the infrared image warning sensor 110 to the missile warning processing module 340.

The missile warning processing module 340 then analyzes each pixel in each frame of imagery data and thresholds each pixel based on pixel brightness and either obtains an existing track point from memory or initiates a new track point based on the threshold. The missile warning processing module 340 then obtains a confidence factor based on evaluating each track point on a frame-by-frame basis.

The missile warning processing module 340 issues a declaration when the obtained confidence factor exceeds a predetermined confidence factor to point the 2 axis micro-gimbal steerable mirror assembly 330 to the track point and corrects the 2 axis micro-gimbal steerable minor assembly 330 pointing using a pointing estimate based on lower latency data at the threat IRSAM. The missile warning processing module 340 further modulates the Band 1 and Band 4 lasers with locally stored jam codes for a predetermined length of time to provide multiple simultaneous IRSAM engagement protection. The jam codes are stored in local memory and they are modulation waveforms that are applied to the laser output. The local energy storage device averages out the power drawn from the lasers over the modulation waveforms. In some embodiments, if the obtained confidence factor exceeds the predetermined confidence factor then the ultralight IRCM points the 2 axis micro-gimbal mirror assembly 330 to the track location using a pointing estimate based on lower latency data at the threat IRSAM. The missile warning processing module 340 further modulates the Band 1 and Band 4 lasers with locally stored, am codes obtained for a predetermined length of time to provide multiple simultaneous IRSAM engagement protection.

In some embodiments, the missile warning processing module 340 turns-off the Band 1 and Band 4 lasers and the 2 axis micro-gimbal steerable mirror assembly once the jam codes are complete. Further in sonic embodiments, the missile warning processing module 340 turns-on the Band 1 and Band 4 lasers and the 2 axis micro-gimbal steerable mirror assembly to provide provide multiple simultaneous IRSAM engagement protection when the confidence factors exceeds the predetermined confidence factor next time.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby, enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An ultralight laser infrared countermeasure (IRCM) system comprising:
an ultralight housing
a laser or an infrared missile warning sensor configured to provide imagery data upon detecting a threat infrared surface to air (IRSAM); and
an ultralight laser infrared assembly, wherein the laser or an infrared missile warning sensor and the ultralight laser infrared assembly are disposed to provide the needed alignment and orientation in the ultralight housing, wherein the ultralight laser infrared assembly comprises:
a laser;
a laser pointer assembly; and
a missile warning processing module disposed in the housing to produce a track point for the laser and to produce a modulation signal based on the imagery data, wherein the ultralight laser infrared assembly to modulate the laser pointer assembly based on modulation signal for a predetermined length of time to provide multiple simultaneous IRSAM engagement protection.

2. The system of claim 1, wherein the laser or an infrared missile warning sensor and the ultralight laser infrared assembly are disposed in the ultralight housing to provide the needed alignment between the laser or an infrared missile warning sensor and the laser pointer assembly and to further provide the needed orientation between tracker image orientation to sensor image orientation.

3. The system of claim 1, wherein the a laser or infrared missile warning sensor comprises a imaging ultraviolet (UV) missile warning sensor or an infrared (IR) focal plane array (FPA) based missile warning sensor.

4. The system of claim 1, wherein the infrared missile warning sensor is configured to detect photons from the IRSAM either in the UV or IR bands and converted into electrons to provide frame-by-frame of imagery data upon detecting a threat infrared surface to air missile (IRSAM).

5. The system of claim 4, wherein the missile warning processing module analyzes each pixel in each frame of imagery data and thresholds each pixel based on pixel brightness and either obtains an existing track point: from memory or initiates a new track point based on the threshold, and Wherein the missile warning processing module obtains a confidence factor based on evaluating each track point on a frame-by-frame basis.

6. The system of claim 5, wherein the laser is Band 1 and Band 4 lasers.

7. The system of claim 5, wherein the laser pointer assembly is a 2 axis micro-gimbal steerable mirror assembly, wherein the missile warning processing module issues a declaration when the obtained confidence factor exceeds a predetermined confidence factor to point the axis micro-gimbal steerable mirror assembly to the track point and corrects the 2 axis micro-gimbal steerable minor assembly pointing using a pointing estimate based on lower latency data at the threat IRSAM and wherein the missile warning processing module further modulates the Band 1 and Band 4 lasers with locally stored jam codes obtained from a local energy storage device for a predetermined length of time to provide multiple simultaneous IRSAM engagement protection.

8. The system of claim 7, wherein the missile warning processing module turns-off the Band 1 and Band 4 lasers and the 2 axis micro-gimbal steerable mirror assembly once the jam codes are complete.

9. The system of claim 8, wherein the missile warning processing module turns-on the Band 1 and Band 4 lasers and the 2 axis micro-gimbal steerable mirror assembly to provide multiple simultaneous IRSAM engagement protection when the confidence factors exceeds the predetermined confidence factor next time.
